(19) United States
(12) Patent Application Publication
(10) Pub. No.: US 2017/0347629 A1
(43) Pub. Date: Dec. 7, 2017

(54) Corrective Collar Activator System

(71) Applicant: Chloe Hyesung Lee, Beverly Hills, CA (US)

(72) Inventor: Chloe Hyesung Lee, Beverly Hills, CA (US)

(21) Appl. No.: 15/175,025

(22) Filed: Jun. 6, 2016

(51) Int. Cl. A01K 27/00; A01K 15/02

(52) U.S. Cl. CPC A01K 27/003; A01K 15/02

(57) ABSTRACT

This invention is a system that will properly activate common corrective collars. Additionally this invention prevents harm to the animal from the misuse of said corrective collars and/or from the uncontrolled animal wearing said collar.

### BACKGROUND

Corrective collars such as choke chains (U.S. Pat. No. 2,616,394), Martingale collars, choke collars (US 20120060770), etc. are used to correct behavior in dogs. Basically corrective collars are simple nooses formed by looping the collar material through a ring. Pulling on the free end of the noose causes the collar to constrict with the ring acting as a virtual stationary point. Consequently pulling on the ring end of the collar does not cause the collar to constrict.

In normal operation the user attaches a leash to the free end of the collar and the collar looped loosely around the neck of the dog. When a corrective action is required the user pulls on the leash to cause a constricting force around the neck of the dog. The correct operation should cause a feeling that simulates the feel of a mother dog' s bite and release. This is achieved by a quick jerk and release of the leash.

When operated correctly, corrective collars do not harm the dog. Unfortunately the majority of users incorrectly operate the collars. They pull too hard, causing excessive pressure on the dog' s neck leading to trachea and/or throat problems and in server cases broken neck. Another incorrect usage is where a user, instead of providing a jerk and release action, continues to pull the leash causing slow strangulation of the dog or similarly where the user allows the dog to continuously pull on the leash. It would therefore be desirous to have a system that easily ensure the proper operation of corrective collars and prevents harm to the dog.

### BRIEF DESCRIPTION OF THE DRAWINGS

FIG. 1 is a view of the corrective collar activator system.

FIG. 2 is a cut-away view of the corrective collar activator.

FIG. 3. is a view of the corrective collar activator system attached to a common corrective collar.

FIG. 4 is a view of a typical corrective collar activator system usage.

### DETAILED DESCRIPTION

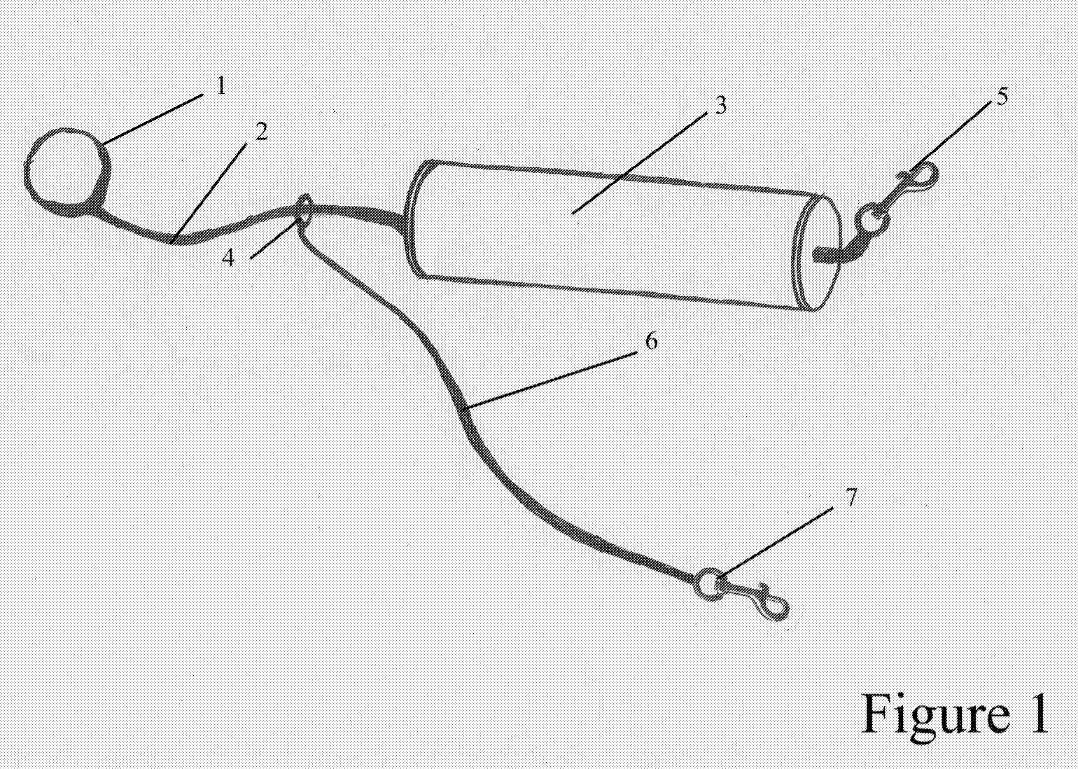

FIG. 1 shows the corrective collar activator system. The system consists of leash attach ring 1 connected to the activator cord 2, which runs through safety cord ring 4 and into the corrective collar activator 3. Connected to safety cord ring 4 is safety cord 6 with safety leash hook 7 connect at the end. Collar hook 5 is connected to the corrective collar activator 3.

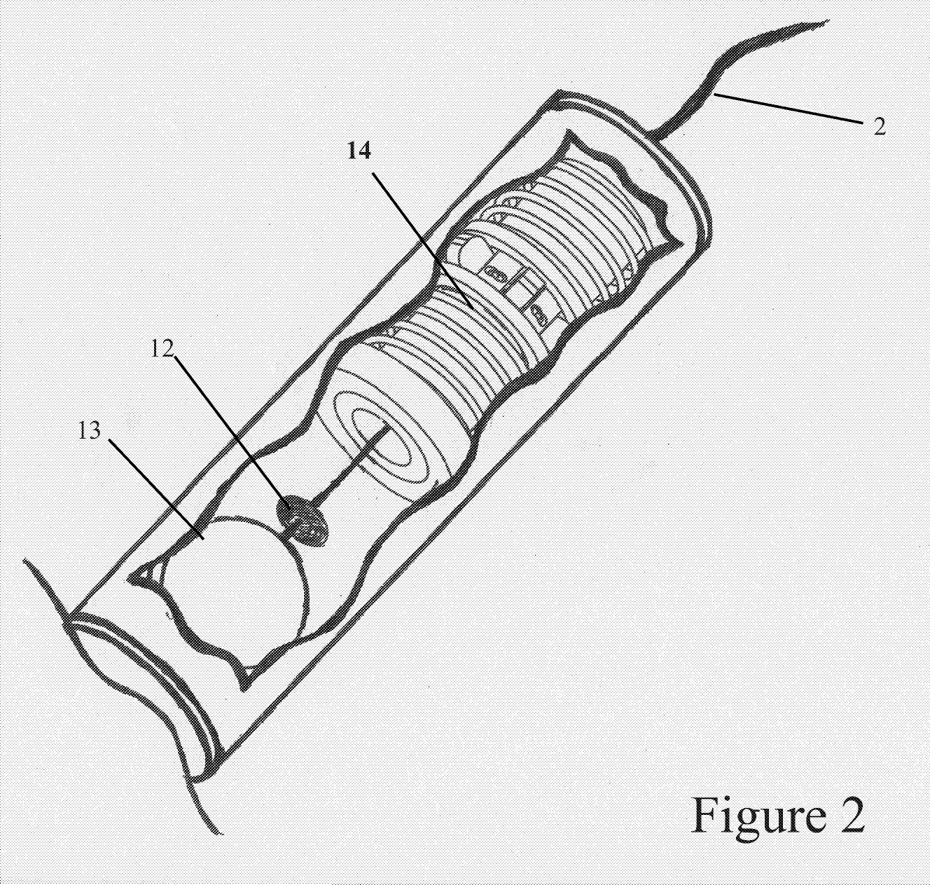

FIG. 2 shows a cut away view of corrective collar activator 3. Activator cord 2 passes through the Asymmetric Latch Release Mechanism 14 (Chloe Hyesung Lee, inventor; Chloe Hyesung Lee, assignee. Asymmetric Latch Release Mechanism. U.S. patent application Ser. No. 14/880,220. Oct. 10, 2015) and is retracted into the cord retractor 13. Cord retractor 13 is attached to the base of the corrective collar activator 3. Engagement grommet 12 is affixed to activator cord 2.

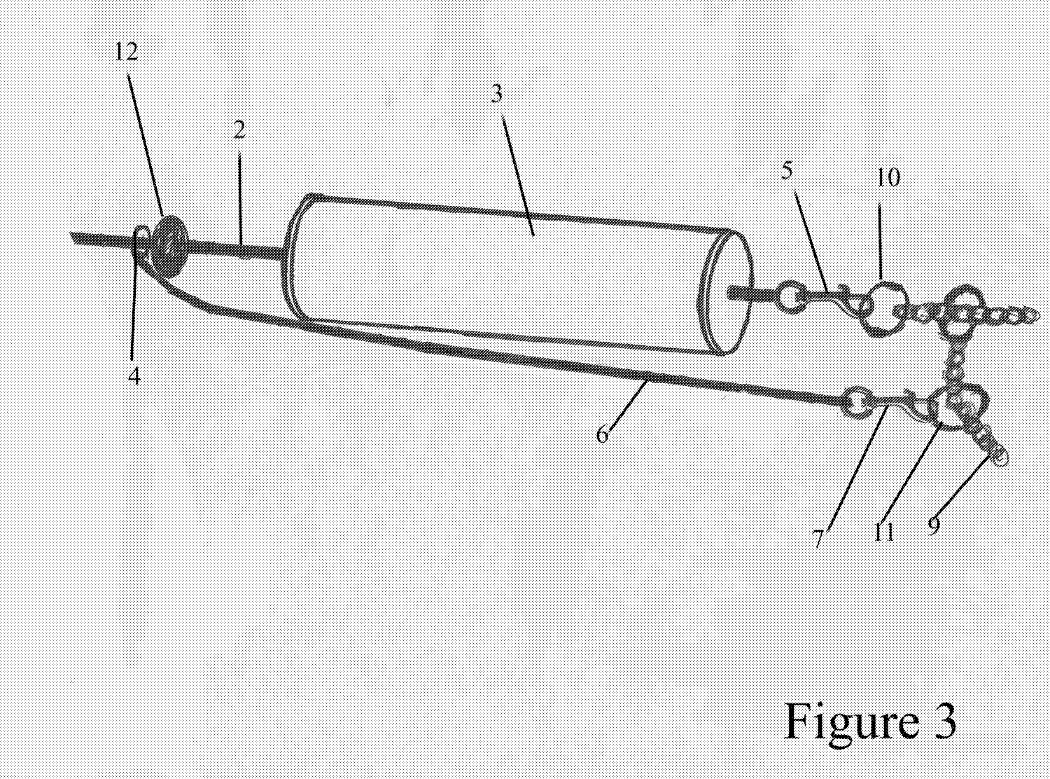

FIG. 3. shows the corrective collar activator system attached to a common corrective collar. The collar hook 5 is attached to the free end ring 10 of the corrective collar 9. The safety collar hook 7 is attached to the stationary end ring 10 of the corrective collar 9.

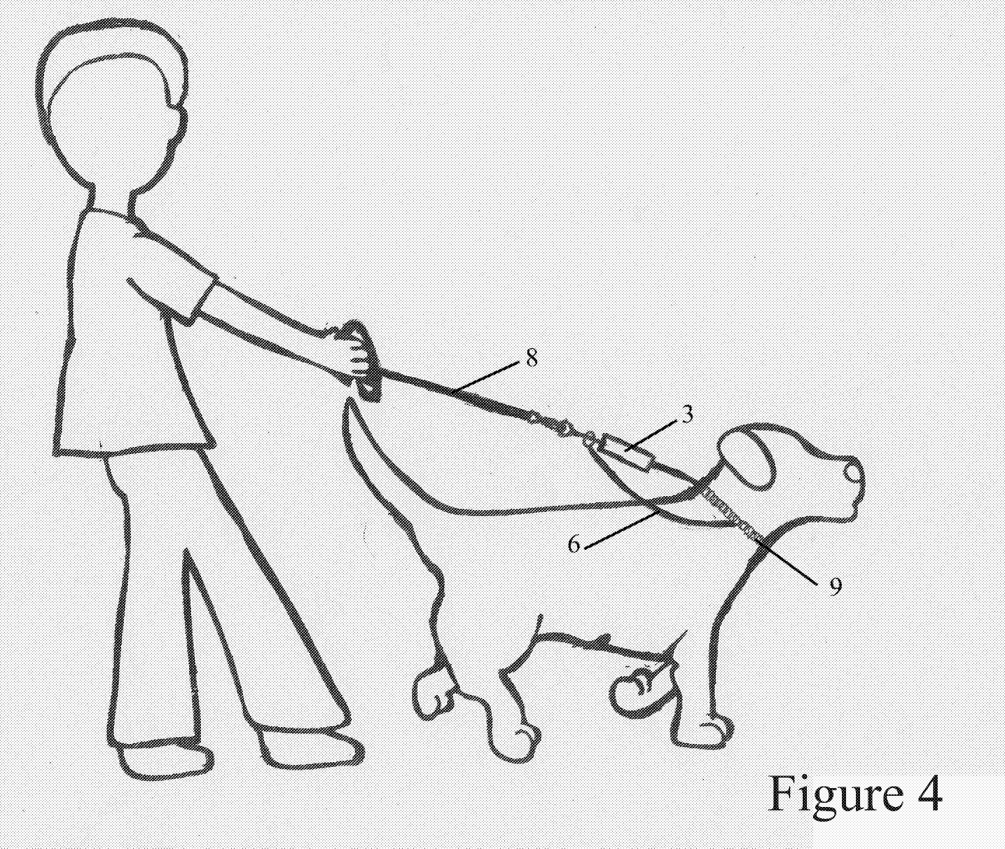

FIG. 4. shows a typical corrective collar activator system usage. The user's leash 8 is attached to leash attach ring 1.

In operation the activator cord 2 is retracted within cord retractor 13 such that the engagement grommet 12 is resting against the cord retractor 13. The length of activator cord 2 within the cord retractor 13 is much longer than the length of safety cord 6. The activator cord 2 from the other side of the engagement grommet passes through the Asymmetric Latch Release Mechanism 14 and out the top of the corrective collar activator 3 to be attached to the user's leash 8. There is low tension on the leash 8 and hence low tension on the corrective collar 9. This is the inactivated state of operation.

At some point the user initiates a corrective action by pulling on leash 8. This causes the activator cord 2 to be unwound from the cord retractor 13. This unwinding of the activator cord 2 causes the engagement grommet 12 to enter the Asymmetric Latch Release Mechanism 14. Here the engagement grommet 12 is held within the Asymmetric Latch Release Mechanism 14. The pull force on the leash 8 is transfer to the free end of the corrective collar 9 causing the corrective collar 9 to constrict. As the pull force on the leash 8 continues the engagement grommet 12 exerts a force on the Asymmetric Latch Release Mechanism 14. Once this force exceeds the release force of the Asymmetric Latch Release Mechanism 14, the engagement grommet 12 is released from the Asymmetric Latch Release Mechanism 14 and passes through it and out of the corrective collar activator 3. This removes the force applied to the corrective collar 9 and thus relaxes the constriction of the corrective collar 9. So by a simple pull on the leash 8, the corrective collar activator system has caused the proper activation of the corrective collar 9. This is the activated state of operation.

Once the corrective action has been applied the user relaxes the tension on leash 8. The cord retractor 13 retracts the activator cord 2 and causes engagement grommet 12 to pass inside the corrective collar activator 3 until it rests against the cord retractor 13. The system has returned to the inactivated state.

In some cases, after the system has been in the active state, the user is unable to relax the tension on leash 8 to return the system to the inactive state but instead continues to apply pull pressure on the leash 8. This causes the activator cord 2 to continue to be unwound from the cord retractor 13 and the engagement grommet 12 to travel further away from the corrective collar activator 3. As the length of activator cord 2 within the cord retractor 13 is much longer than the safety cord 6, the engagement grommet 12 will eventually contact the safety cord ring 4. At this point the tension on the leash 8 is transferred via the safety cord 6 to the stationary end of the corrective collar 9 via the stationary end ring 11. Pulling on the stationary end of the corrective collar 9 will not cause the corrective collar 9 to constrict. Thus, continuously pulling on leash 8 will not harm the dog.

1. A corrective collar activator system, comprising:
a) a flexible member with a ring attached at one end
b) a second flexible member with a ring and a hook attached at opposite ends and
c) an asymmetric latch release mechanism and
d) a rigid member and
e) a cord retractor mechanism and
f) a hook
g) said length of flexible member being passed through said ring of second flexible member and through said asymmetric latch release mechanism and retracted into said cord retract or mechanism and
h) said rigid member attached to said flexible member such that with said flexible member retracted within said cord retractor said rigid member is attached between said asymmetric latch release mechanism and said cord retractor mechanism and
i) said cord retractor mechanism attached to said hook
